(19) United States
(12) Patent Application Publication
(10) Pub. No.: US 2006/0056603 A1
(43) Pub. Date: Mar. 16, 2006

(54) Systems and methods for providing voicemail notifications

(76) Inventor: John Eric Harrity, Centreville, VA (US)

Correspondence Address: JOHN E. HARRITY, 11240 WAPLES MILL ROAD, SUITE 300, FAIRFAX, VA, 22030, US

(21) Appl. No.: 10/938,498

(22) Filed: Sep. 13, 2004

(51) Int. Cl. H04M 1/64

(52) U.S. Cl. 379/88.12

(57) ABSTRACT

A system may detect retrieval of a voicemail message from a calling party and notify the calling party in response to the detecting.

### FIELD OF THE INVENTION

Implementations consistent with the principles of the invention relate generally to voicemail systems, and more specifically, to providing voicemail notifications.

### BACKGROUND OF THE INVENTION

The ability to create and store a voicemail message for another individual is well known. In some instances, it may be desirable to know when the voicemail message is retrieved by the other individual.

### SUMMARY OF THE INVENTION

In accordance with one implementation consistent with the principles of the invention, a method includes receiving a voicemail message from a first party; determining whether the first party is to be notified when the voicemail message is retrieved; requesting notification information from the first party when the first party is to be notified when the voicemail message is retrieved, where the notification information includes calling party contact information; associating the notification information with the voicemail message; detecting that the voicemail message is retrieved; capturing a current date and time in response to the detecting; and notifying the calling party of the captured date and time using the notification information.

In another implementation consistent with the principles of the invention, a system may include first logic configured to receive a voicemail message from a first party; and second logic configured to notify the first party when the voicemail message is retrieved.

In a further implementation consistent with the principles of the invention, a method may include detecting retrieval of a voicemail message from a calling party; and notifying the calling party in response to the detecting.

In yet a further implementation consistent with the principles of the invention, a computer-readable medium containing a data structure relating to voicemail retrieval notification is provided. The computer-readable medium may include a first area that stores first information that indicates whether a party that has created a voicemail message is to be notified when the voicemail message is retrieved; and a second area that stores second information associated with the party.

### BRIEF DESCRIPTION OF THE DRAWINGS

The accompanying drawings, which are incorporated in and constitute a part of this specification, illustrate an implementation of the invention and, together with the description, explain the invention. In the drawings,

FIG. 1 is an exemplary diagram of a system in which systems and methods consistent with the principles of the invention may be implemented;

FIG. 2 is an exemplary diagram of the voicemail system of FIG. 1 in an implementation consistent with the principles of the invention;

FIG. 3 is an exemplary diagram of a database that may be associated with the voicemail system of FIG. 1 in an implementation consistent with the principles of the invention;

FIG. 4 is a flow chart of an exemplary process for processing an incoming voicemail message in an implementation consistent with the principles of the invention;

FIG. 5 is a flow chart of an exemplary process for providing voicemail notification in an implementation consistent with the principles of the invention; and

FIG. 6 is an exemplary notification message in an implementation consistent with the principles of the invention.

### DETAILED DESCRIPTION

The following detailed description of implementations consistent with the principles of the invention refers to the accompanying drawings. The same reference numbers in different drawings may identify the same or similar elements. Also, the following detailed description does not limit the invention.

### Exemplary System

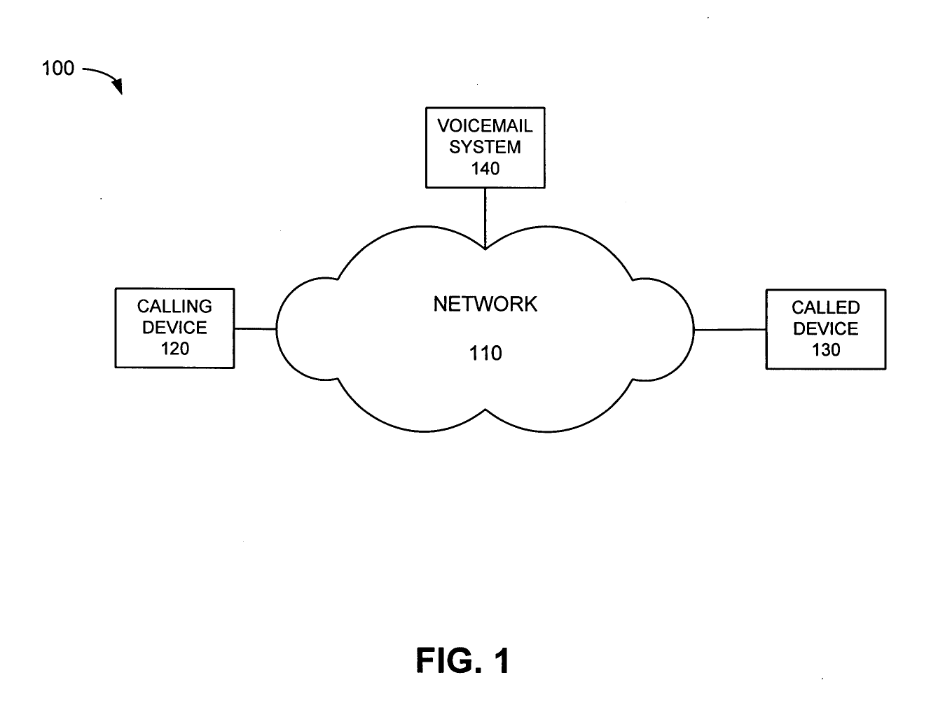

FIG. 1 is an exemplary diagram of a system 100 in which systems and methods consistent with the principles of the invention may be implemented. System 100 may include a calling device 120, a called device 130, and a voicemail system 140 connected via a network 110. Network 110 may include a local area network (LAN), a wide area network (WAN), a telephone network, such as the Public Switched Telephone Network (PSTN), an intranet, the Internet, a similar or dissimilar network, or a combination of networks. The number of devices illustrated in FIG. 1 has been provided for simplicity. In practice, there may be more or fewer calling devices 120, called devices 130, and/or voicemail systems 140. Also, in some instances, calling device 120 or called device 130 may perform the functions of voicemail system 140 and voicemail system 140 may perform the functions of calling device 120 or called device 130.

Calling device 120 and called device 130 may include any type of device capable of transmitting voice signals over and receiving voice signals from a network, such as network 110. Calling device 120 and called device 130 may include, for example, a Plain Old Telephone Service (POTS) telephone, a computer device that transmits voice signals over and receives voice signals from network 110, a cellular telephone, etc. Calling device 120 and called device 130 may also include any client (e.g., a computer device, a web-appliance, etc.) that is configured to provide Session Initiated Protocol (SIP) telephone functions. In this situation, calling device 120 and called device 130 may take the form of standalone devices—e.g., a SIP telephone may be designed and configured to function and appear like a POTS telephone. Calling device 120 and called device 130 may also include a software client that may run, for example, on a conventional personal computer (PC), lap top, a personal digital assistant (PDA), or another type of computation or communication device.

Voicemail system 140 may include one or more devices capable of receiving voicemail messages, storing voicemail messages, and providing voicemail messages. In other implementations, voicemail system 140 may manage a system that receives voicemail messages, stores voicemail messages, and provides voicemail messages. As will be described in detail below, voicemail system 140 may notify a calling party that left a voicemail message for a called party when the voicemail message is retrieved. Calling device 120, called device 130, and voicemail system 140 may connect to network 110 via wired, wireless, and/or optical connections.

### Exemplary Server Configuration

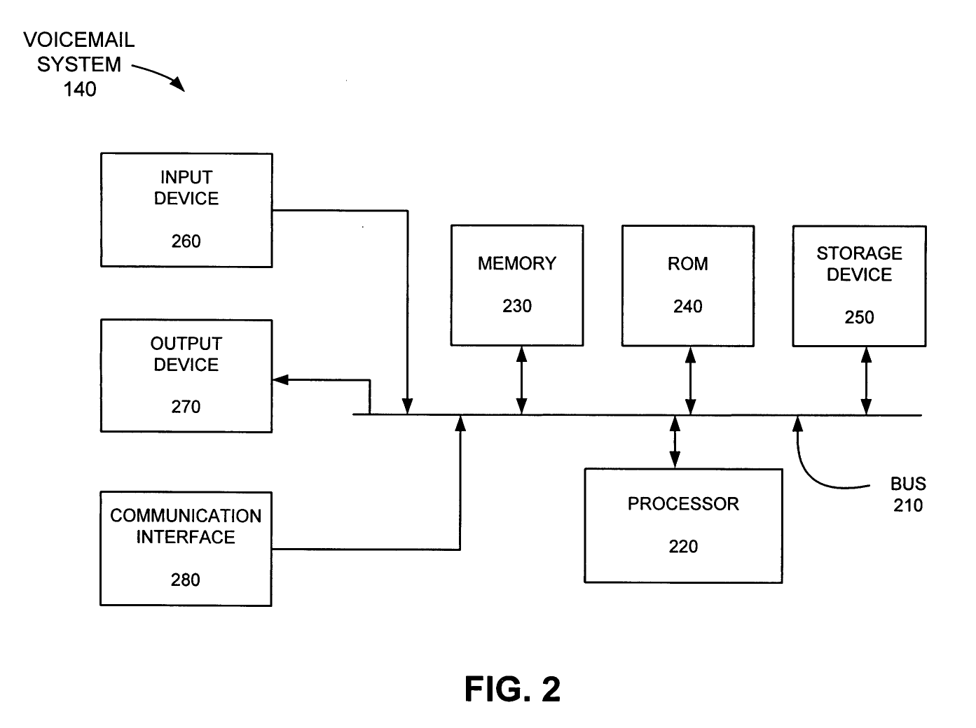

FIG. 2 is an exemplary diagram of voicemail system 140 in an implementation consistent with the principles of the invention. Calling device 120 and called device 130 may, in some implementations consistent with the principles of the invention, be similarly configured. Voicemail system 140 may include a bus 210, a processor 220, a main memory 230, a read only memory (ROM) 240, a storage device 250, an input device 260, an output device 270, and a communication interface 280. Bus 210 may permit communication among the components of voicemail system 140.

Processor 220 may include any type of conventional processor, microprocessor, or logic (e.g., a field programmable gate array, application specific integrated circuit, etc.) that interprets and executes instructions. Main memory 230 may include a random access memory (RAM) or another type of dynamic storage device that stores information and instructions for execution by processor 220. ROM 240 may include a conventional ROM device or another type of static storage device that stores static information and instructions for use by processor 220. Storage device 250 may include a magnetic and/or optical recording medium and its corresponding drive.

Input device 260 may include a mechanism that permits an administrator to input information to voicemail system 140, such as a keyboard, a mouse, a pen, a biometric mechanism, such as a voice recognition device, etc. Output device 270 may include a mechanism that outputs information to the administrator, including a display, a printer, a speaker, etc. Communication interface 280 may include any transceiver-like mechanism that enables voicemail system 140 to communicate with other devices and/or systems. For example, communication interface 280 may include mechanisms for communicating with another device or system via a network, such as network 110.

As will be described in detail below, voicemail system 140, consistent with the principles of the invention, may notify individuals that have left a voicemail message for another party when that voicemail message is retrieved. Voicemail system 140 may perform these and other operations in response to processor 220 executing software instructions contained in a computer-readable medium, such as memory 230. A computer-readable medium may be defined as one or more memory devices and/or carrier waves. The software instructions may be read into memory 230 from another computer-readable medium, such as data storage device 250, or from another device via communication interface 280. The software instructions contained in memory 230 may cause processor 220 to perform processes that will be described later. Alternatively, hardwired circuitry may be used in place of or in combination with software instructions to implement processes consistent with the principles of the invention. Thus, systems and methods consistent with the principles of the invention are not limited to any specific combination of hardware circuitry and software.

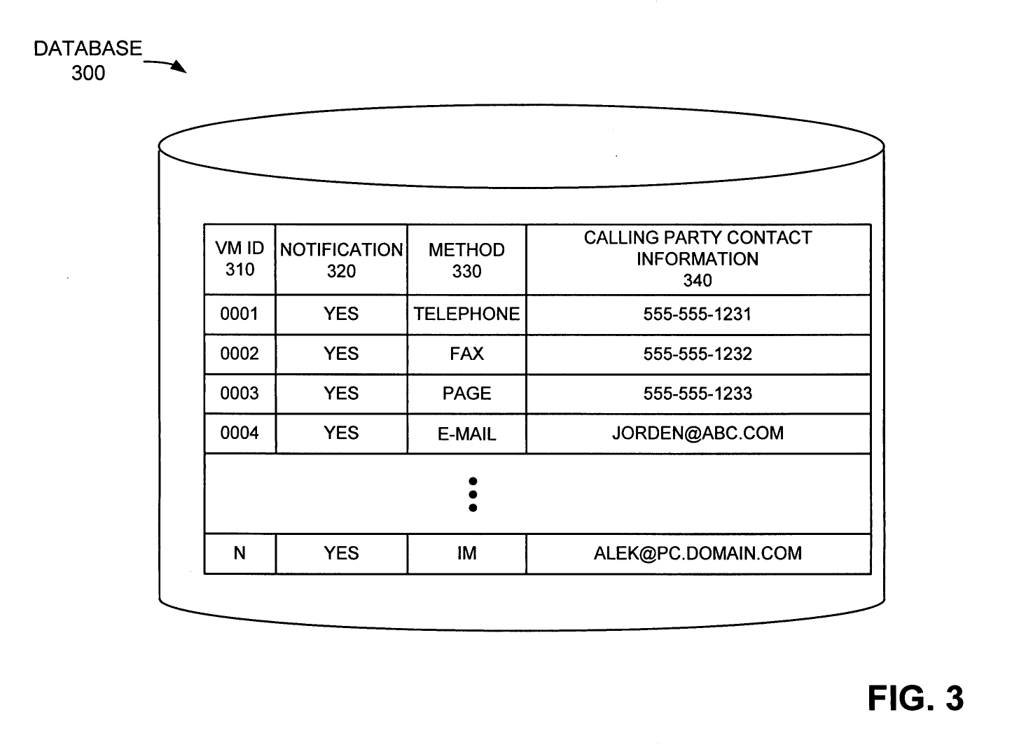

FIG. 3 is an exemplary diagram of a database 300 that may be associated with voicemail system 140 in an implementation consistent with the principles of the invention. While only one database is described below, it will be appreciated that database 300 may consist of multiple databases stored locally at voicemail system 140, or stored at different locations throughout network 110. Moreover, voicemail system 140 may include a single database 300 for all subscribers associated with voicemail system 140 or may include a separate database 300 for each subscriber associated with voicemail system 140.

As illustrated, database 300 may includes a group of entries. Each entry may include information stored in one or more of the following exemplary fields: a voicemail (VM) identification (ID) field 310, a notification field 320, a notification method field 330, and calling party contact information field 340. Database 300 may contain additional fields (not shown) that aid the voicemail system 140 in providing voicemail message retrieval notifications.

Voicemail identification field 310 may store an identifier that uniquely identifies a stored voicemail message. The identifier may include, for example, a unique group of characters. Some or all of these characters may identify the called party (i.e., the subscriber to the voicemail system for which a voicemail message was stored). Alternatively or in addition, voicemail identification field 310 may store a date identifier and time identifier that indicate when the associated voicemail message was stored.

Notification field 320 may store information indicating whether the calling party that created the voicemail message desires to be notified when the voicemail message is retrieved. It will be appreciated that in those instances when the calling party does not desire to be notified when their voicemail message is retrieved, corresponding fields 330 and 340 may not be populated.

Notification method field 330 may store information identifying the type of device to which a notification message is to be transmitted. Voicemail system 140 may, for example, allow the calling party to be notified via telephone, facsimile, pager, electronic mail (e-mail), instant message (IM), etc. Other types of notification methods are also possible. For example, voicemail system 140 may provide a notification that is mailed to the calling party.

Calling party contact information field 340 may store a destination address of the notification message. The destination address may include, for example, a telephone number, a facsimile number, a pager number, an e-mail address, an IM address, etc.

### Exemplary Processing

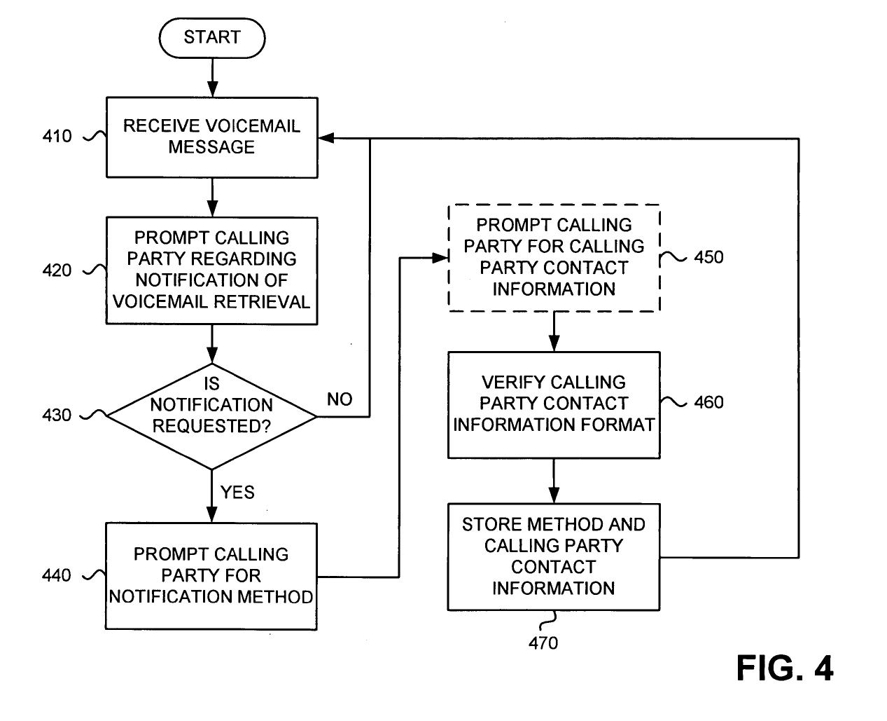

FIG. 4 is a flow chart of an exemplary process for processing an incoming voicemail message in an implementation consistent with the principles of the invention. Processing may begin by receiving a voicemail message (act 410). The voicemail message may be received in a conventional manner. For example, a calling party using calling device 120 may place a telephone call to a called party at called device 130. When the called party does not answer, the telephone call may be forwarded to voicemail system 140 where an introductory message may be played for the calling party. The calling party may then create the voicemail message.

Voicemail system 140 may ask the calling party whether the calling party wants to be notified when the voicemail message is retrieved (act 420). For example, voicemail message may play a prerecorded message prior to or after the voicemail message has been created by the calling party. The prerecorded message may ask “Would you like to be notified when your message is retrieved? Press 1 for YES and 2 for NO.” Voicemail system 140 may alternatively use voice recognition techniques for identifying whether the calling party wishes to be notified when the voicemail message is retrieved.

The calling party's indication as to whether or not a notification is desired may be received (act 430). If the calling party indicates that a notification is not desired (act 430), processing can return to act 410 with the next voicemail message being received. If, on the other hand, the calling party indicates that a notification is desired (act 430), the calling party may be prompted for the method by which the calling party desires to be notified (act 440). In one implementation consistent with the principles of the invention, voicemail system 140 may play a prerecorded message to the calling party. The prerecorded message may, for example, ask “How would you like to be notified when your message is retrieved? Press 1 if by telephone, 2 if by fax, 3 if by pager, 4 if by e-mail, or 5 if by instant messenger.” Voicemail system 140 may alternatively use voice recognition techniques for identifying the manner in which the calling party wishes to be notified when the voicemail message is retrieved.

The calling party may optionally be prompted for contact information at which the calling party desires to be notified (act 450). Voicemail system 140 may use voice recognition (or other) techniques for capturing the contact information from the calling party. In one implementation consistent with the principles of the invention, if the calling party desires to be notified by telephone, voicemail system 140 may use automatic number identification (ANI) techniques to identify the telephone number from which the calling party has placed the call. In this situation, voicemail system 140 may verify the telephone number with the calling party.

Voicemail system 140 may verify the format of the contact information provided by the calling party (act 460). If the calling party indicated that notification is to be by e-mail and the network address provided by the calling party does not match an e-mail address format, then the calling party may be requested to provide the network address again.

Voicemail system 140 may store the notification method and calling party contact information in, for example, database 300 (act 470). Voicemail system 140 may also store the date and time that the calling party provided the voicemail message and/or an identifier associated with the voicemail message. The identifier and/or date and time information may be used by voicemail system 140 to retrieve the correct entry from database 300 when a voicemail message is retrieved.

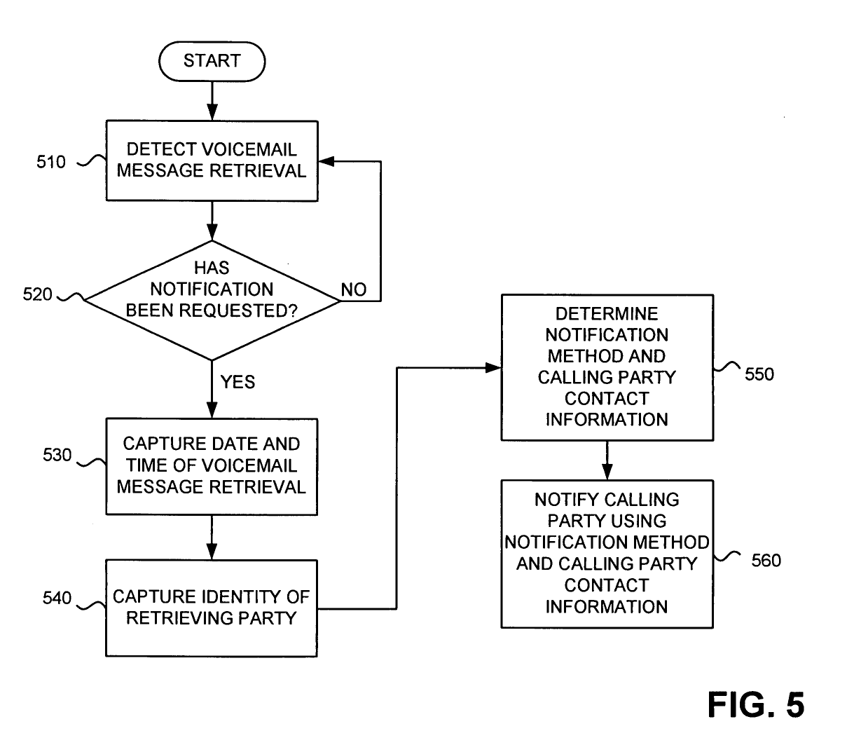

FIG. 5 is a flow chart of an exemplary process for providing voicemail notification in an implementation consistent with the principles of the invention. Processing may begin with voicemail system 140 detecting that a voicemail message has been retrieved (act 510). Voicemail system 140 may determine whether a notification request is associated with the voicemail message (act 520). Voicemail system 140 may make this determination by, for example, looking up the appropriate entry in database 300 that corresponds to the voicemail message. As indicated above, notification field 320 may store information that indicates whether the calling party that provided the voicemail message wishes to be notified when the message is retrieved.

If the calling party has not indicated that a notification is desired (act 520), processing may return to act 510 when voicemail system 140 detects that another voicemail message has been retrieved. If, on the other hand, the calling party has indicated that a notification is desired (act 520), voicemail system 140 may capture the date and time of the voicemail retrieval (act 530).

Voicemail system 140 may capture the identity of the retrieving party (act 540). For example, voicemail system 140 may ask, prior to or after the voicemail is retrieved by the retrieving party, that the party speak his/her name. Voicemail system 140 may then store the name in, for example, memory 230, as an audio file or may translate the name to text. Alternatively, voicemail system 140 may condition the retrieval of the voicemail message on the party identifying his/her name.

Voicemail system 140 may determine the notification method and calling party contact information (act 550). Voicemail system 140 may make this determination by, for example, looking up the appropriate entry in database 300 that corresponds to the voicemail message. As indicated above, notification method field 330 may store information that indicates the device by which the calling party that created the voicemail message wishes to be notified and calling party contact information field 340 may store the contact information (e.g., network address) by which the calling party wishes to be notified.

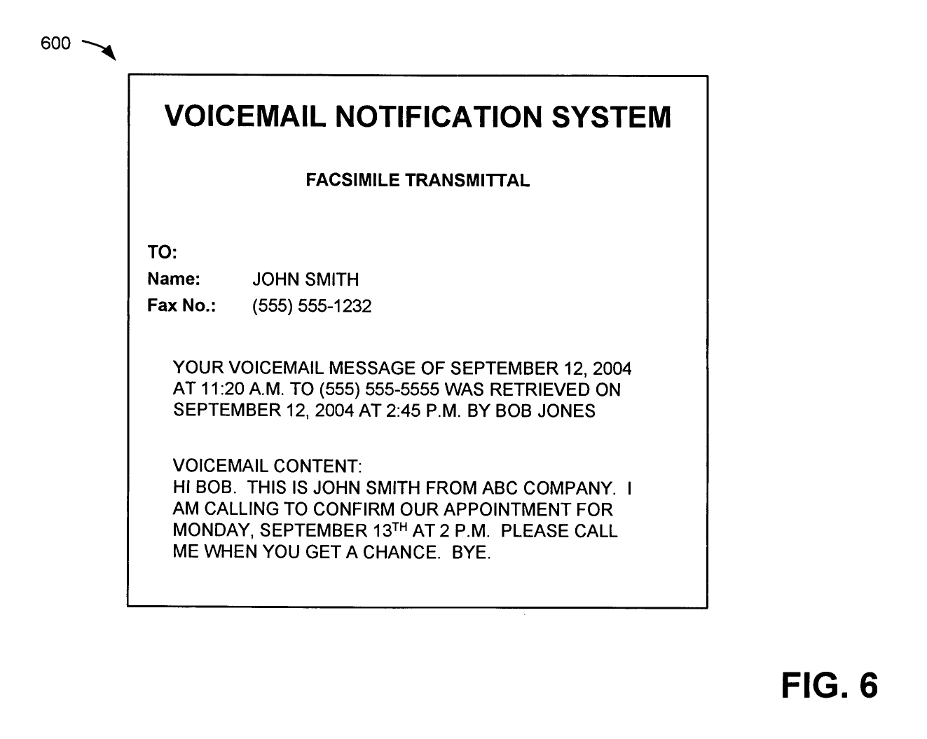

Voicemail system 140 may notify the calling party using the appropriate notification method and calling party contact information (act 560). For example, if the calling party indicated that notification by facsimile is desired, voicemail system 140 may send a fax notification to the calling party using the facsimile number provided by the calling party at the time that the voicemail message was created. FIG. 6 is an exemplary facsimile notification message 600 in an implementation consistent with the principles of the invention. As illustrated, facsimile notification message 600 may indicate the date and time that the voicemail message was created by the calling party, the telephone number (and possibly the identity of the owner) associated with the voicemail account, the date and time that the voicemail message was retrieved, and the identity of the person retrieving the voicemail message. In this way, the calling party has written verification that his/her voicemail message was retrieved. In other implementations, voicemail system 140 may use voice-to-text translation techniques to translate the calling party's voicemail message to text. In these situations, notification message 600 may also include the text of the voicemail message left by the calling party.

In a similar manner, if the calling party indicated that notification by instant message or e-mail is desired, voicemail system 140 may send an instant message (or e-mail) notification to the calling party using the instant message (or e-mail) address provided by the calling party at the time that the voicemail message was created. The instant message (or e-mail) may indicate the same information described above with respect to facsimile notification message 600. In one implementation consistent with the principles of the invention, voicemail system 140 may append the voicemail message and/or retrieving party's identity as audio attachments.

If the calling party indicated that notification by pager is desired, voicemail system 140 may send a page to the calling party using the pager number provided by the calling party at the time that the voicemail message was created. If the calling party indicated that notification by telephone is desired, voicemail system 140 may place a telephone call to the calling party using the telephone number provided by the calling party at the time that the voicemail message was created. In this situation, voicemail system 140 may provide an automated message to the calling party indicating when the voicemail message was retrieved. The message may also indicate when the calling party created the voicemail message. In other implementations, voicemail system 140 may also play the voicemail message that was created by the calling party to the calling party, along with the identity of the retrieving party.

### CONCLUSION

Implementations consistent with the principles of the invention provide notification when voicemail messages are retrieved.

The foregoing description of exemplary embodiments of the invention provides illustration and description, but is not intended to be exhaustive or to limit the invention to the precise form disclosed. Modifications and variations are possible in light of the above teachings or may be acquired from practice of the invention. For example, it will be appreciated that the techniques described above may also be applied to home voicemail machines (also called “answering machines”). In this situation, however, the manner in which the notification is provided may be limited.

Moreover, while not described above, in some implementations consistent with the principles of the invention, the subscriber to voicemail system 140 may be given the ability to turn off voicemail retrieval notification.

While series of acts have been described with regard to FIGS. 4 and 5, the order of the acts may be varied in other implementations consistent with the invention. Moreover, non-dependent acts may be implemented in parallel.

It will also be apparent to one of ordinary skill in the art that aspects of the invention, as described above, may be implemented in many different forms of software, firmware, and hardware in the implementations illustrated in the figures. The actual software code or specialized control hardware used to implement aspects consistent with the principles of the invention is not limiting of the invention. Thus, the operation and behavior of the aspects of the invention were described without reference to the specific software code—it being understood that one of ordinary skill in the art would be able to design software and control hardware to implement the aspects based on the description herein.

Further, certain portions of the invention may be implemented as “logic” that performs one or more functions. This logic may include hardware, such as an application specific integrated circuit or a field programmable gate array, software, or a combination of hardware and software.

No element, act, or instruction used in the description of the invention should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method comprising:
receiving a voicemail message from a first party;
determining whether the first party is to be notified when the voicemail message is retrieved;
requesting notification information from the first party when the first party is to be notified when the voicemail message is retrieved, the notification information including calling party contact information;
associating the notification information with the voicemail message;
detecting that the voicemail message is retrieved;
capturing a current date and time in response to the detecting; and
notifying the calling party of the captured date and time using the notification information.

2. The method of claim 1 wherein the notifying includes:
placing a telephone call to the calling party when the voicemail message is retrieved.

3. The method of claim 1 wherein the notifying includes:
paging the calling party when the voicemail message is retrieved.

4. The method of claim 1 wherein the notifying includes:
sending a facsimile to the calling party when the voicemail message is retrieved.

5. The method of claim 1 wherein the notifying includes:
sending an electronic mail message to the calling party when the voicemail message is retrieved.

6. The method of claim 1 wherein the notifying includes:
sending an instant message to the calling party when the voicemail message is retrieved.

7. The method of claim 1 wherein the notifying includes:
providing a content of the voicemail message.

8. The method of claim 7 wherein the providing includes:
translating the voicemail message to text.

9. The method of claim 7 wherein the notifying further includes:
providing a date and time that the voicemail message was created.

10. The method of claim 1 further comprising:
verifying a format of the notification information.

11. The method of claim 1 further comprising:
capturing an identity of a party retrieving the voicemail message, and
wherein the notifying includes:
providing the captured identity to the first party.

12. A system comprising:
first logic configured to receive a voicemail message from a first party; and
second logic configured to notify the first party when the voicemail message is retrieved.

13. The system of claim 12 wherein, when notifying the first party, the second logic is configured to:
notify the second party via one of a telephone call, a facsimile, a page, an electronic mail message, or a instant message.

14. The system of claim 12 further comprising:
third logic configured to prompt the calling party for notification information in response to the first logic receiving the voicemail message.

15. The system of claim 14 wherein the notification information includes a notification method and calling party contact information.

16. The system of claim 14 wherein the third logic is further configured to:
automatically detect a telephone number of the calling party.

17. A method comprising:
detecting retrieval of a voicemail message from a calling party; and
notifying the calling party in response to the detecting.

18. The method of claim 17 wherein the notifying includes:
placing a telephone call to the calling party when the voicemail message is retrieved.

19. The method of claim 17 wherein the notifying includes:
paging the calling party when the voicemail message is retrieved.

20. The method of claim 17 wherein the notifying includes:
sending a facsimile to the calling party when the voicemail message is retrieved.

21. The method of claim 17 wherein the notifying includes:
sending an electronic mail message to the calling party when the voicemail message is retrieved.

22. The method of claim 17 wherein the notifying includes:
sending an instant message to the calling party when the voicemail message is retrieved.

23. The method of claim 17 further comprising:
obtaining an identity of a party retrieving the voicemail message, and
wherein the notifying includes:
providing the identity to the calling party.

24. A computer-readable medium containing a data structure relating to voicemail retrieval notification, comprising:
a first area that stores first information that indicates whether a party that has created a voicemail message is to be notified when the voicemail message is retrieved; and
a second area that stores second information associated with the party.

25. The computer-readable medium of claim 24 further comprising:
a third area that stores third information identifying a manner in which the party is to be notified.
